(19) United States
(12) Patent Application Publication
(10) Pub. No.: US 2012/0028752 A1
(43) Pub. Date: Feb. 2, 2012

(54) FLYWHEEL MODULE

(76) Inventors: Roell Marie Van Druten, Eindhoven (NL); Bas Gerard Vroemen, Eindhoven (NL); Alexander Franciscus Anita Serrarens, Wallre (NL)

(21) Appl. No.: 13/146,262

(22) PCT Filed: Jan. 27, 2010
(86) PCT No.: PCT/NL2010/050039

§ 371 Date: Oct. 17, 2011

(30) Foreign Application Priority Data
Jan. 27, 2009 (NL) 2002453

(51) Int. Cl. F16H 3/44

(52) U.S. Cl. 475/269

(57) ABSTRACT

A flywheel module comprises a coupling unit which has an input shaft and an output shaft. This coupling unit has a first coupling of which a first coupling half can be connected to a combustion engine and a second coupling half can be connected to a continuously variable transmission. The flywheel module further comprises a flywheel unit which has an in/output and is formed by a flywheel and a reduction gear unit connected to the flywheel. This flywheel unit is exclusively connected to the in/output via the coupling unit.

### FIELD OF THE INVENTION

The invention relates to a flywheel module to be used in a vehicle provided with a driving source and a transmission.

The flywheel module comprises:

a coupling unit comprising:
an input shaft, which can be coupled to the driving source, and
an output shaft, which can be coupled to the transmission,

and comprising a first coupling, which is present between the input shaft and the output shaft and which comprises:
a first coupling half connected to the input shaft, and
a second coupling half connected to the output shaft,

as well as

a flywheel unit having an in/output and including:
i) a flywheel, and
ii) a reduction gear unit having an input which is connected to the flywheel and an output which is connected to the in/output of the flywheel unit, and comprising:
   a) a reduction gearing as well as
   b) a coupling device which is connected to the reduction gearing.

### STATE OF THE ART

A transmission system comprising a flywheel module of this type is known from U.S. Pat. No. 5,569,108. In the known transmission system the flywheel unit is connected with its in/output and furthermore with a further in/output to the coupling unit, while this further in/output is connected to the first coupling half of the first coupling. The reduction gearing in this known flywheel module is formed by a planetary gear set having three rotational members, a first rotational member of which being connected to the flywheel, a second rotational member being connected via a brake to a node positioned between the second coupling half and the output shaft and the third rotational member being connected via a brake to the further in/output. This known flywheel module is relatively complex.

### SUMMARY OF THE INVENTION

It is an object of the invention to provide a flywheel module of the type defined in the opening paragraph, which is less complex than the known flywheel module. For this purpose the flywheel module according to the invention is characterised, in that the flywheel unit is connected with its in/output to the coupling unit, this in/output being connected via a node to the second coupling half of the first coupling and/or to the output shaft. The flywheel unit is preferably exclusively connected with its in/output to the coupling unit. Furthermore, preferably the first coupling is closed in non-energized state.

The transmission is preferably a continuously variable transmission and may be a mechanical (pulleys with push belt or chain), a powersplit mechanical, an electrical, or a powersplit electrical continuously variable transmission. The driving source may be a combustion engine or an electromotor.

The flywheel module further preferably comprises a hydraulic pump which is connected to the node. If the continuously variable transmission comprises an input shaft as well as an output shaft and also a pulley on each shaft and an endless flexible transmission element around the pulleys, at least one pulley disc of one of the pulleys being in a position to be moved from and to the other pulley disc of the pulley, the pump can provide piston displacement by means of a piston connected to this pulley, which piston is displaceable in a hydraulic cylinder. The pump can be directly connected to the node, so that the latter automatically rotates in unison with the driving source.

A disadvantage of this is that at a low speed of the driving source the output (flow) of the pump is low. Sometimes rapid switching is to be performed and a high flow is required, for example in case of an emergency stop or a tip shift. This requires the pump to be designed for high flow at low speed. At higher speeds the pump then often produces too much flow and the pump is then actually over-dimensioned, so that it produces more losses than necessary. At low, sub-normal speeds (no high flow) the pump is then over-dimensioned and produces more losses than necessary also in this situation.

An additional disadvantage of this is that if the driving source is switched off, for example in a hybrid application (idle stop, start stop), no pressure is available for enabling the launch of the vehicle.

An embodiment of the flywheel module according to the invention, in which the aforementioned disadvantages do not occur is characterized, in that the flywheel module comprises a hydraulic buffer which is connected to the pump. As a result, the pump may be down-sized (caused to deliver less flow), while under normal working conditions the flow is still sufficient for all its functions to be performed, so that no energy is wasted. In the case where much flow is needed, the accumulator can help out. Besides, the accumulator can produce pressure if the driving source is in the off mode.

The flywheel module further preferably comprises en electromotor which can drive the pump, as well as a freewheel bearing which is positioned between on the one hand the pump plus electromotor and the node on the other. The pump then does not have a direct connection to the node. In consequence, the pump can electrically be brought to a higher speed than the input shaft of the CVT, so that the pump may be down-sized further. The electromotor is operated in start-stop mode in which the hydraulic accumulator is charged.

It should be observed that the pump and accumulator or the pump and accumulator and electromotor and freewheel bearing can also be advantageously applied to a module without a flywheel unit.

The flywheel module can be a separate module which can be built in in a simple fashion in an already existing drive of a vehicle. To this end an embodiment of the flywheel module according to the invention is characterised, in that the flywheel module further includes:
first coupling means, for coupling the input shaft to the driving source, as well as
second coupling means, for coupling the output shaft to the transmission, which first and second coupling means are arranged as splines present on or in the input and output shafts.

A further embodiment of the flywheel module according to the invention is characterised in that the reduction gearing is formed by a gear transmission.

In one embodiment the coupling device is formed by a second coupling which is connected to the reduction gearing, the reduction gearing being positioned between the second coupling and the flywheel. Preferably, the second coupling is open in non-energized state.

In another embodiment the coupling device comprises a coupling support device as well as a planetary gear set comprising three rotational members, a first rotational member of which being connected to the coupling support device, a second rotational member being connected to the gear transmission and the third rotational member being connected to the in/output of the flywheel unit. The coupling support device preferably comprises an electromotor or a brake.

A further embodiment of the flywheel module according to the invention is characterised, in that the flywheel unit further comprises a further flywheel which is connected to the gear transmission.

Another embodiment of the flywheel module according to the invention is characterised, in that the reduction gearing is formed by a planetary gear set and the coupling device is formed by a friction brake, which gear set comprises three rotational members, a first rotational member of which being connected to the flywheel, a second rotational member being connected to the output of the reduction gear unit and the third rotational member being connected to the friction brake.

A still further embodiment of the flywheel module according to the invention is characterised, in that a third coupling is positioned between the flywheel and the reduction gear unit.

Yet another embodiment of the flywheel module according to the invention is characterised, in that the flywheel is located in an airtight housing in which there is underpressure, with the third coupling being arranged as a magnetic coupling of which one coupling half is located inside the housing and is connected to the flywheel and the other coupling half is located outside the housing.

For obtaining additional functionality a still further embodiment of the transmission system according to the invention is characterised, in that the in/output of the flywheel unit is further connected to the first coupling half of the first coupling, with a fourth coupling being positioned between the in/output of the flywheel module and the first coupling half.

A further reduction gearing is preferably positioned between the in/output of the flywheel module and the node.

Yet again a further embodiment of the flywheel module according to the invention is characterised, in that the flywheel module further includes an electrical machine which is connected to the node or to the further reduction gearing if there is a further reduction gearing positioned between the in/output of the flywheel module and the node.

The invention further also relates to a transmission system for use in a vehicle that comprises a driving source arranged as a combustion engine and driven wheels, which transmission system comprises a transmission having a first in/output shaft and a second in/output shaft which can be connected to the driven wheels, as well as a flywheel module according to the invention, of which the input shaft can be coupled to the combustion engine and the output shaft can be coupled to the first in/output of the transmission, between the node and the first or second in/output shaft of the transmission there being positioned a fifth coupling. The fifth coupling is preferably open in non-energized state.

Preferably all component parts, except for the flywheel, are present in a further housing which is in open connection to or integral with the housing of the transmission.

The invention further relates to a method for starting a combustion engine of a vehicle during driving, which vehicle comprises driven wheels in addition to the combustion engine and a transmission system according to the invention positioned therebetween, while during the driving the first coupling is open and the second and fifth couplings are closed. With respect to this method the invention is characterised, in that the fifth coupling is operated in slipping fashion, on which occasion the first coupling is closed and the combustion engine is started, after which the fifth coupling is closed completely.

Furthermore, the invention relates to a method for starting a combustion engine of a vehicle during the launch, which vehicle comprises driven wheels in addition to the combustion engine as well as a transmission system according to the invention positioned therebetween, at the time of the launch of the vehicle the first coupling being open, the second coupling being closed and the fifth coupling being in a slipping mode. With respect to this method the invention is characterised, in that prior to the fifth coupling being closed completely, the first coupling is closed, on which occasion the combustion engine is started, after which the fifth coupling is closed completely.

### BRIEF DESCRIPTION OF THE DRAWINGS

The invention will be further elucidated below in more detail with reference to examples of embodiments of the flywheel module and the transmission system according to the invention and represented in the drawing figures, in which:

FIG. 1 shows a first embodiment of the flywheel module according to the invention, in which the reduction gear unit is arranged as a planetary gear set and a friction brake;

FIG. 2 shows a second embodiment of the flywheel module according to the invention, in which the reduction gear unit is arranged as a gear transmission and a coupling;

FIG. 3 shows a third embodiment of the flywheel module according to the invention, in which the flywheel unit is further connected to the first coupling half of the first coupling;

FIG. 4 shows a fourth embodiment of the flywheel module according to the invention, in which a fifth coupling is present between the node and the transmission;

FIG. 5 shows a fifth embodiment of the flywheel module according to the invention, in which the coupling device is formed by a planetary gear set and an electromotor;

FIG. 6 shows a sixth embodiment of the flywheel module according to the invention, comprising a hydraulic system;

FIG. 7 shows a seventh embodiment of the flywheel module according to the invention, in which the flywheel module is provided with coupling means;

FIGS. 8-10 show three variants of the flywheel module shown in FIG. 7; and

FIGS. 11-13 show concrete embodiments of the flywheel modules shown in FIGS. 8-10.

### DETAILED DESCRIPTION OF THE DRAWINGS

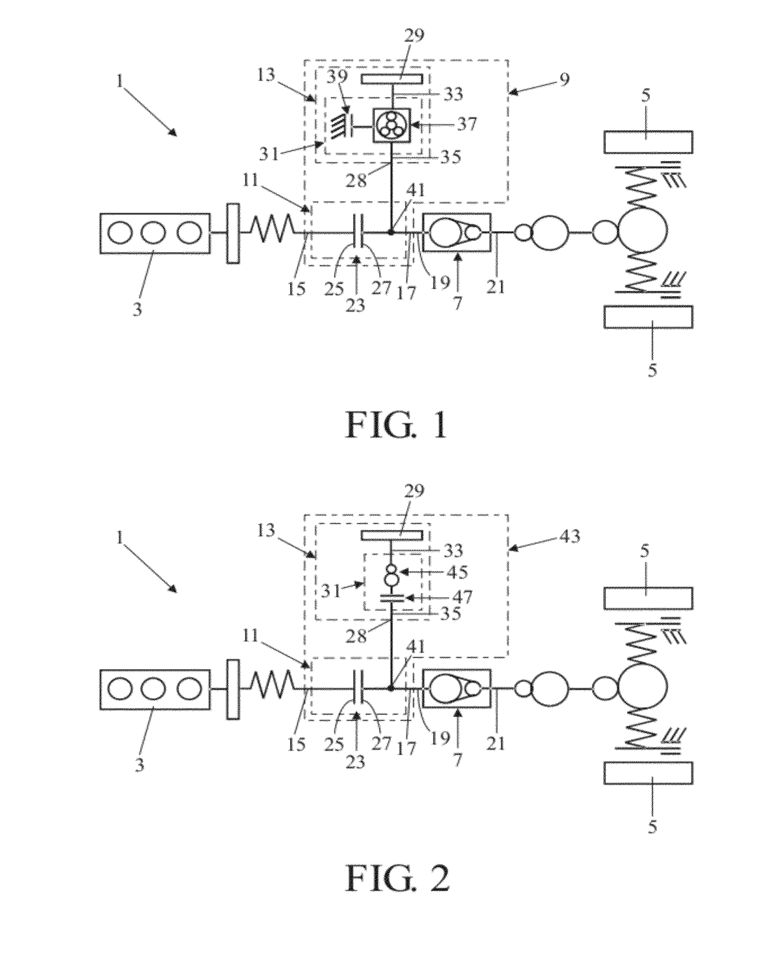

FIG. 1 shows a layout of a vehicle comprising a transmission system in a first embodiment of the flywheel module according to the invention. The vehicle 1 has a driving source 3 which is connected to the driven wheels 5 via a transmission system. The transmission system comprises a transmission 7 and a flywheel module 9 positioned between the driving source and transmission.

The flywheel module 9 comprises a coupling unit 11 and a flywheel unit 13. The coupling unit comprises an input shaft 15 which is connected to the driving source, and an output shaft 17 which is connected to a first in/output 19 of the transmission 7. A second in/output 21 of the transmission is connected to the driven wheels 5. The coupling unit further comprises a first coupling 23 which comprises a first coupling half 25 connected to the input shaft, and a second coupling half 27 connected to the output shaft.

The flywheel unit comprises an in/output 28 as well as a flywheel 29 and a reduction gear unit 31 which has an input 33 connected to the flywheel, and an output 35 which is connected to the in/output of the flywheel unit. The reduction gear unit comprises a reduction gearing and a coupling device connected to the reduction gearing. The reduction gear unit is comprised of a reduction gearing and a coupling device. The reduction gearing is in this case formed by a planetary gear set 37 and the coupling device by a friction brake 39. This planetary gear set 37 comprises three rotational members, a first rotational member of which being connected to the flywheel 29, a second rotational member being connected via a node 41 to the coupling device 11, and the third rotational member being connected to the friction brake 39.

FIG. 2 shows a layout of a vehicle comprising a second embodiment of the flywheel module according to the invention. All components that are equal to those of the first embodiment shown in FIG. 1 are designated by like reference numerals. This flywheel module differs from the first embodiment in that the reduction gear unit 31 comprises a gear transmission 45 and a second coupling 47 which is arranged as a friction coupling. There may even be positioned a third coupling (not shown) between the flywheel 29 and the reduction gear unit 31.

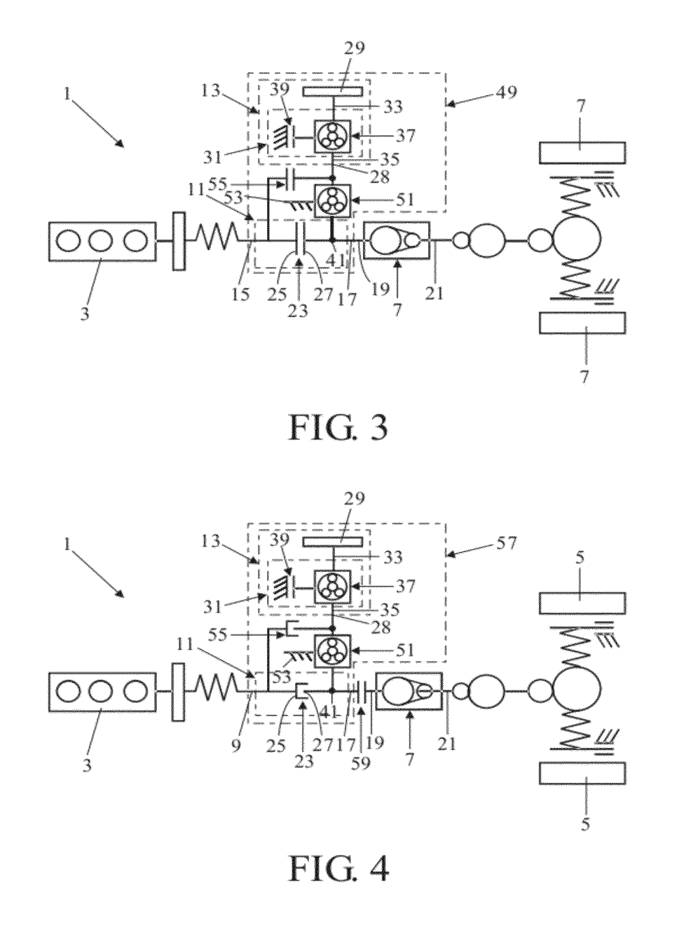

FIG. 3 shows a layout of a vehicle comprising a third embodiment of the flywheel module according to the invention. All components that are equal to those of the first embodiment shown in FIG. 1 are designated by like reference numerals. This flywheel module 49 comprises a further reduction gearing 51 between the in/output 28 of the flywheel unit 13 and the node 41. This reduction gearing 51 is formed by a further planetary gear set having three rotational members, a first rotational member of which being connected to the in/output 28, a second rotational member being connected to the node 41, and the third rotational member being connected to the firm object 53, for example the housing of the transmission system.

In this flywheel module 49 the in/output 28 of the flywheel unit 13 is further connected to the first coupling half 25 of the first coupling 23 via a fourth coupling 55. The first coupling 23 and the fourth coupling 55 are both arranged as a friction coupling.

FIG. 4 shows a layout of a vehicle comprising a fourth embodiment of the flywheel module according to the invention. All components that are equal to those of the third embodiment shown in FIG. 3 are designated by like reference numerals. This flywheel module 57 differs from the third embodiment in that yet a fifth coupling 59 is present between the node 41 and the continuously variable transmission 7. Furthermore, the first coupling 23 and the fourth coupling 55 are both arranged as a claw coupling or synchromesh.

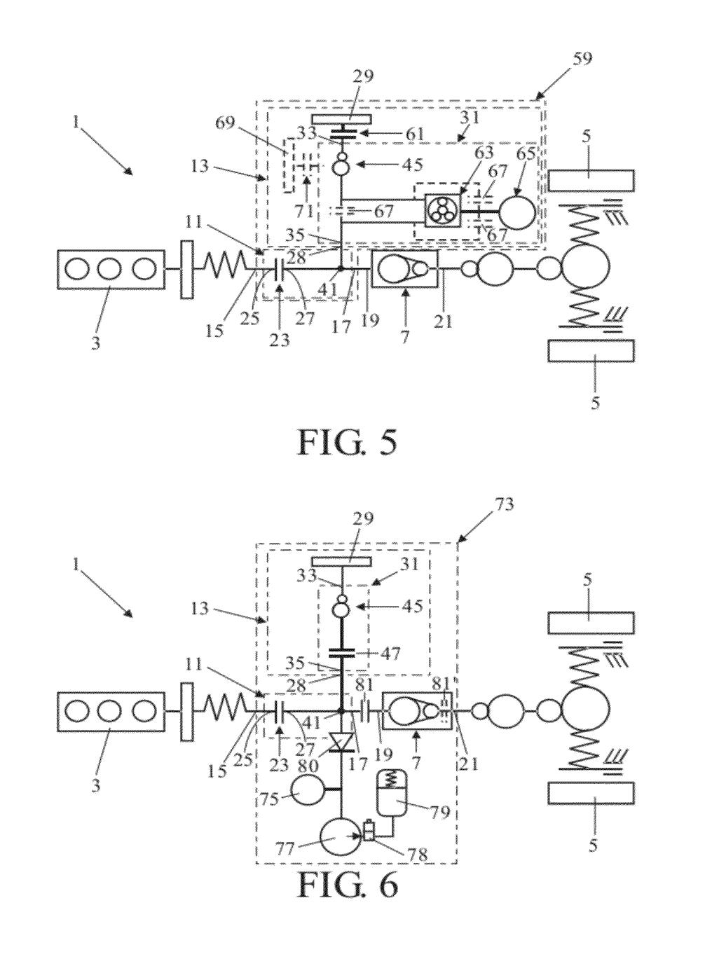

FIG. 5 shows a layout of a vehicle comprising a fifth embodiment of the flywheel module according to the invention. All components that are equal to those of the second embodiment shown in FIG. 2 are designated by like reference numerals. In this flywheel module 59 the third coupling 61 is positioned between the gear transmission 45 and the flywheel 29. Furthermore, in this case the coupling device is formed by a planetary gear set 63 and a coupling support device 65, which in this embodiment is formed by an electromotor and is connected to one of the rotational members of the planetary gear set. In this embodiment yet a further coupling 67 (indicated in broken lines) may be positioned between two out of three rotational members of the planetary gear set 63. In addition, a further flywheel 69 can be connected to the reduction gearing 45 via yet another coupling 71 (also indicated in broken lines).

FIG. 6 shows a layout of a vehicle comprising a sixth embodiment of the flywheel module according to the invention. All components that are equal to those of the second embodiment shown in FIG. 2 are designated by like reference numerals. In this flywheel module 73 an electrical machine in the form of an electromotor/generator 75 and a hydraulic pump 77 are connected to the node 41 and, furthermore, a hydraulic accumulator 79 is connected to the pump 77. Here too, there is a fifth coupling 81 between the node and the first in/output shaft 19 of the transmission 7. The fifth coupling, however, may also be present in the secondary shaft of the transmission 7 (designated by 81′). The first coupling 23 is preferably a coupling that is normally closed, which is to say that if this coupling is not operated/energized, it is closed. The second and fifth couplings 47 and 81 are preferably normally open.

In this flywheel module 73 the electromotor 75 is positioned close to the pump 77 and, furthermore, a freewheel bearing 80 is positioned between on the one hand the pump 77 and the electromotor 75 and on the other hand the node 41. Between the pump and the accumulator there is a valve 78 for shutting off and releasing the connection between the two. The electromotor 75 can be instrumental in bringing the pump 77 to a higher speed than the input shaft 19 of the transmission 7, so that the pump can be downsized further. The electromotor 75 is operated in the start-stop mode during which the hydraulic accumulator 79 is charged.

Prior to the launch of the vehicle, the coupling 81 is first to be closed and the coupling 23 to be opened. Now the vehicle can be launched on the electromotor 75 while the pressure for operating the couplings 23 and 81 and the transmission 7 is supplied by the hydraulic accumulator 79.

For starting the driving source 3 of the vehicle during driving (coupling 81 closed and coupling 23 open), the coupling 81 is operated in a slipping manner while coupling 23 is open. Subsequently, the coupling 23 is closed while the driving source 3 embodied as a combustion engine is started, after which the coupling 81 is closed completely.

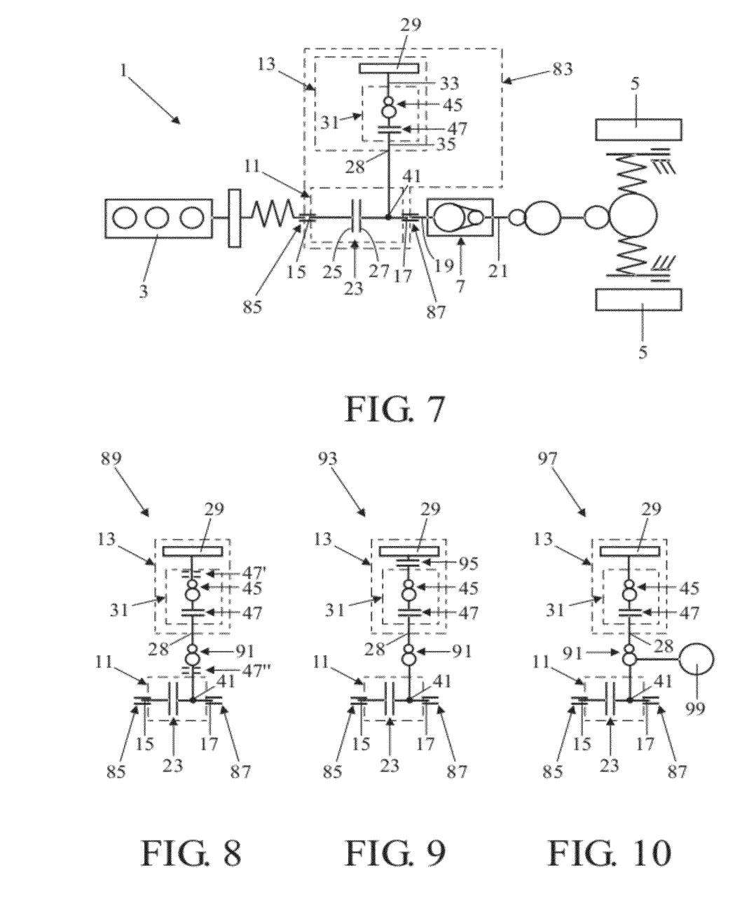

FIG. 7 shows a seventh embodiment of the flywheel module according to the invention. This flywheel module 83 comprises first coupling means 85 for coupling the input shaft 15 to the driving source 3, and second coupling means 87 for coupling the output shaft 17 to the transmission 7. The first and second coupling means are arranged as splines present on or in the input and output shafts 15, 17.

FIGS. 8, 9 and 10 show three variants of the flywheel module shown in FIG. 7. In the flywheel module 89 shown in FIG. 8 a further reduction gearing 91 is present between the reduction gear unit 31 and the coupling unit 11. The second coupling 47 may then also be positioned between the reduction gearing 45 and the flywheel 29 (designated by 47′) in lieu of between the two reduction gearings 45 and 49, or between the further reduction gearing 49 and the node 41 (designated by 47″). In the flywheel module 93 shown in FIG. 9 a third coupling 95 is further positioned between the reduction gear unit 31 and the flywheel 29, and in the flywheel module 97 shown in FIG. 10 an electromotor 99 is connected to the further reduction gearing 91.

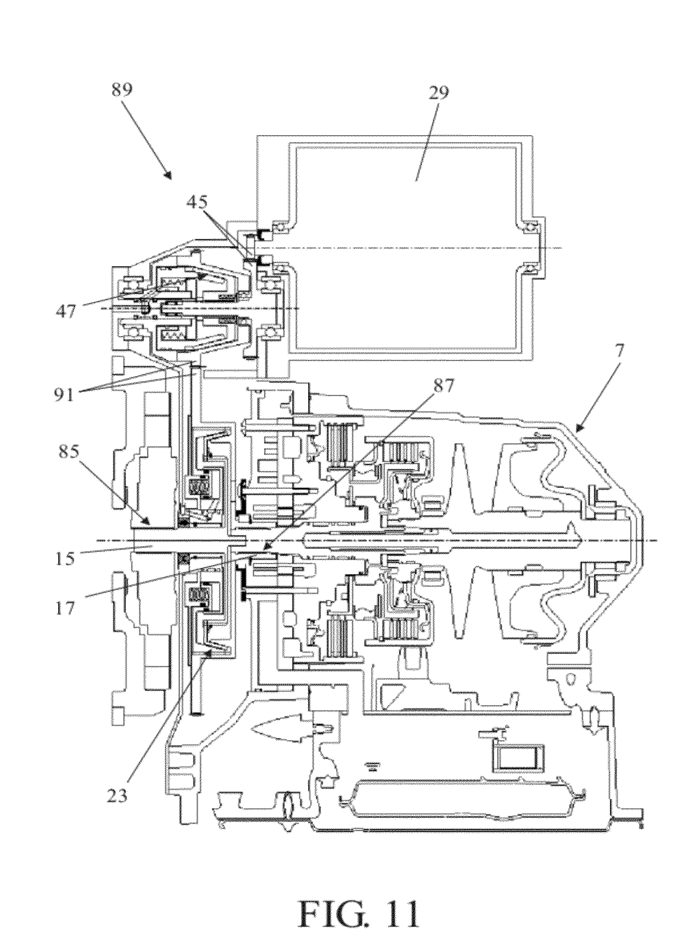

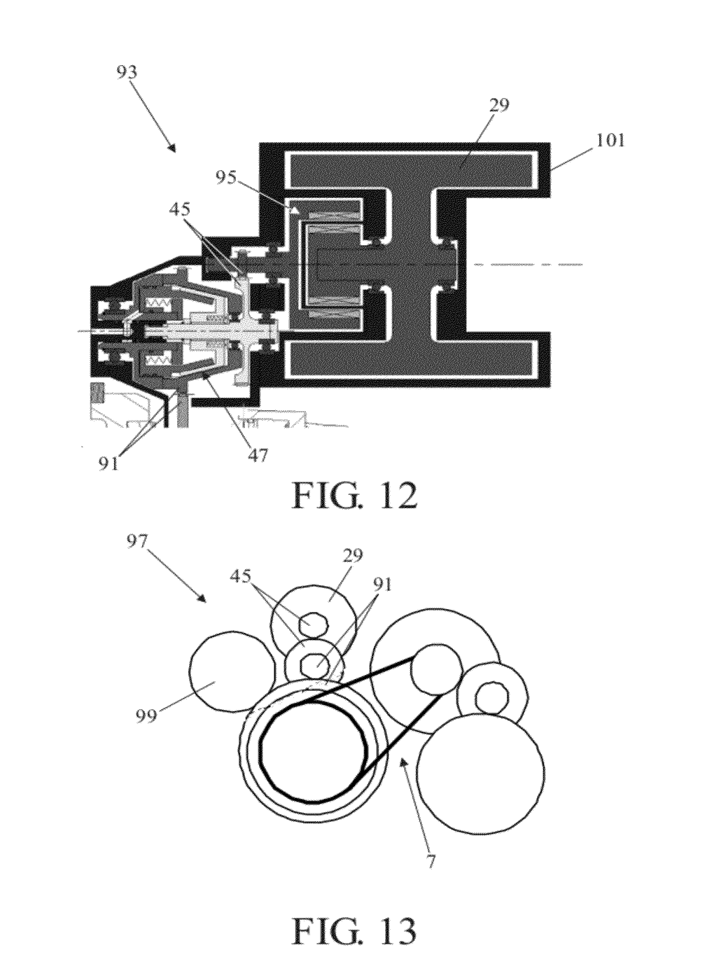

In FIGS. 11, 12 and 13 are shown concrete embodiments of the flywheel modules 89, 93 and 97 shown in FIGS. 8, 9 and 10. In the flywheel module 89 shown in FIG. 11 the input shaft 15 has external splines 85 and the output shaft 17 is hollow and has internal splines 87. In the flywheel module 93 shown in FIG. 12 the flywheel 29 is located in an airtight housing 101 in which there is underpressure. The third coupling 95 is arranged as a magnetic coupling of which one coupling half is located inside the housing 101 and the other coupling half is located outside the housing. In the flywheel module 97 shown in FIG. 13 the electromotor 99 meshes with a gear present on the shaft with a gear of the further reduction gearing 91.

Albeit the invention has been described in the foregoing with reference to the drawing Figures, it should be pointed out that the invention is not by any manner or means restricted to the embodiments shown in the drawing Figures. The invention also extends over any embodiments deviating from the embodiments shown in the drawing Figures within the spirit and scope defined by the claims.

1. A flywheel module to be used in a vehicle provided with a driving source and a transmission, comprising:
a coupling unit comprising:
an input shaft which can be coupled to the driving source, and
an output shaft which can be coupled to the transmission,
and comprising a first coupling which is present between the input shaft and the output shaft and which comprises:
a first coupling half connected to the input shaft, and
a second coupling half connected to the output shaft,
as well as
a flywheel unit having an in/output and including:
iii) a flywheel, and
iv) a reduction gear unit having an input which is connected to the flywheel and an output which is connected to the in/output of the flywheel unit, and comprising:
a) a reduction gearing as well as
b) a coupling device which is connected to the reduction gearing, characterised in that the flywheel unit is connected with its in/output to the coupling unit, this in/output being connected via a node to the second coupling half of the first coupling and/or to the output shaft.

2. A flywheel module as claimed in claim 1, characterised in that the first coupling is arranged such that if it is not energized it is closed.

3. A flywheel module as claimed in claim 1 or 2, characterised in that the flywheel module further includes a hydraulic pump which is connected to the node.

4. A flywheel module as claimed in claim 3, characterised in that the flywheel module further includes a hydraulic buffer which is connected to the pump.

5. A flywheel module as claimed in claim 4, characterised in that the flywheel module comprises an electromotor which can drive the pump, as well as a freewheel bearing which is positioned between on the one hand the pump plus electromotor and the node on the other.

6. A flywheel module as claimed in any one of the preceding claims, characterised in that the flywheel module further includes:
first coupling means, for coupling the input shaft to the driving source, as well as
second coupling means, for coupling the output shaft to the transmission, which first
and second coupling means are arranged as splines present on or in input and output shafts.

7. A flywheel module as claimed in any one of the preceding claims, characterised in that the reduction gearing is formed by a gear transmission.

8. A flywheel module as claimed in claim 7, characterised in that the coupling device is formed by a second coupling which is connected to the reduction gearing, with the reduction gearing being positioned between the second coupling and the flywheel.

9. A flywheel module as claimed in claim 8, characterised in that the first coupling is arranged such that it is closed if it is not energized.

10. A flywheel module as claimed in claim 7, characterised in that the coupling device comprises a coupling support device as well as a planetary gear set comprising three rotational members, a first rotational member of which being connected to the coupling support device, a second rotational member being connected to the gear transmission and the third rotational member being connected to the in/output of the flywheel unit.

11. A flywheel module as claimed in claim 10, characterised in that the coupling support device comprises an electromotor.

12. A flywheel module as claimed in claim 10, characterised in that the coupling support device comprises a brake.

13. A flywheel module as claimed in any one of the preceding claims 7 to 12, characterised in that the flywheel unit further includes a further flywheel which is connected to the gear transmission.

14. A flywheel module as claimed in any one of the preceding claims 1 to 6, characterised in that the reduction gearing is formed by a planetary gear set and the coupling device by a friction brake, which gear set comprises three rotational members, a first rotational member of which being connected to the flywheel, a second rotational member being connected to the output of the reduction gear unit and the third rotational member being connected to the friction brake.

15. A flywheel module as claimed in any one of the preceding claims, characterised in that a third coupling is positioned between the flywheel and the reduction gear unit.

16. A flywheel module as claimed in claim 15, characterised in that the flywheel is located in an airtight housing in which there is underpressure, with the third coupling being arranged as a magnetic coupling of which one coupling half is located inside the housing and is connected to the flywheel and the other coupling half is located outside the housing.

17. A flywheel module as claimed in any one of the preceding claims, characterised in that the in/output of the flywheel unit is further connected to the first coupling half of the first coupling, with a fourth coupling being positioned between the in/output of the flywheel module and the first coupling half.

18. A flywheel module as claimed in any one of the preceding claims, characterised in that a further reduction gearing is positioned between the in/output of the flywheel module and the node.

19. A flywheel module as claimed in any one of the preceding claims, characterised in that the flywheel module further includes an electrical machine which is connected to the node or to the further reduction gearing if there is a further reduction gearing positioned between the in/output of the flywheel module and the node.

20. A transmission system for use in a vehicle that comprises a driving source arranged as a combustion engine and driven wheels, which transmission system comprises a transmission having a first in/output shaft and a second in/output shaft which can be connected to the driven wheels, as well as a flywheel module as claimed in any one of the preceding claims, of which the input shaft can be coupled to the combustion engine and the output shaft can be coupled to the first in/output of the transmission, between the node and the first or second in/output shaft of the transmission there being positioned a fifth coupling.

21. A transmission system as claimed in claim 20, characterised in that the first coupling is arranged such that if it is not energized, it is closed.

22. A transmission system as claimed in claim 20 or 21, characterised in that the all component parts, except for the flywheel, are present in a further housing which is in open connection to or integral with the housing of the transmission.

23. Method for starting a combustion engine of a vehicle during driving, which vehicle comprises driven wheels in addition to the combustion engine and a transmission system as claimed in claim 20, 21 or 22 positioned therebetween, while during the driving the first coupling is open and the second and fifth couplings are closed, characterised in that the fifth coupling is operated in slipping fashion, on which occasion the first coupling is closed and the combustion engine is started, after which the fifth coupling is closed completely.

24. A method for starting a combustion engine of a vehicle during the launch, which vehicle comprises driven wheels in addition to the combustion engine as well as a transmission system as claimed in claim 20, 21 or 22 arranged therebetween, at the time of the launch of the vehicle the first coupling being open, the second coupling being closed and the fifth coupling being in a slipping mode, characterised in that prior to the fifth coupling being closed completely, the first coupling is closed, on which occasion the combustion engine is started, after which the fifth coupling is closed completely.
